(19) United States
(12) Patent Application Publication
(10) Pub. No.: US 2022/0029252 A1
(43) Pub. Date: Jan. 27, 2022

(54) CONTACT UNIT FOR AN ELECTRONIC OR ELECTROCHEMICAL DEVICE

(71) Applicant: I-TEN, Dardilly (FR)

(72) Inventor: Fabien GABEN, Dardilly (FR)

(73) Assignee: I-TEN, Dardilly (FR)

(21) Appl. No.: 17/311,734

(22) PCT Filed: Dec. 24, 2019
(86) PCT No.: PCT/FR2019/000221

§ 371 Date: Jun. 8, 2021

(30) Foreign Application Priority Data
Dec. 24, 2018 (FR) 1874100

(51) Int. Cl. H01M 50/534; H01M 50/54; H01M 10/0525

(52) U.S. Cl. CPC H01M 50/534; H01M 10/0525; H01M 50/54

(57) ABSTRACT

Contact unit for an electronic or electrochemical device such as a battery, intended to create electrical contact with an external conductor element, said electronic or electrochemical device comprising a contact surface defining an electrical connection area, characterized in that the contact unit comprises a first layer, arranged on at least the electrical connection area, this first layer comprising a material filled with electrically conductive particles, preferably a polymer resin and/or a material obtained using a sol-gel process and filled with electrically conductive particles, and even more preferably a polymer resin filled with graphite.

### TECHNICAL FIELD OF THE INVENTION

The present invention relates to electrical contact units for electronic or electrochemical devices, more particularly to the electrical contact units of batteries. It relates more particularly to a method for manufacturing such contact units having a novel architecture that confers thereon and on the electronic or electrochemical devices comprising them an improved service life. The invention can be implemented in particular with lithium ion batteries.

### PRIOR ART

It is known that some types of electronic or electrochemical device such as batteries are very sensitive to moisture. In the case of lithium ion batteries, which represent one example of a battery that is particularly sensitive to moisture, the lithium reacts spontaneously with water, forming lithium hydroxide. The quantity of lithium that has reacted with the water is no longer available for energy storage, which reduces the capacity of the battery by premature ageing. Because of this, the greatest care must be taken during the manufacture of the batteries in order to remain within perfectly anhydrous conditions. Likewise, so as to guarantee the service life thereof over time, the batteries are protected from the external environment by a hermetic encapsulation that avoids the permeation of water liable to cause a new loss of capacity of the battery.

The permeation of water through this encapsulation structure is a well-known phenomenon. The impermeability of an encapsulation is normally expressed as a rate of transmission of water vapor (called in English water vapor transmission rate and abbreviated to WVTR). This rate depends on the materials used, the method of manufacturing same and the thicknesses thereof.

The quality of the encapsulation is of vital importance for lithium ion batteries. The techniques of deposition by ALD (atomic layer deposition) are particularly well adapted for covering the surfaces of batteries in a completely sealed and standard manner; this is described for example in WO 2017/115032 (I-TEN). These techniques make it possible to produce thin films, without defects and perfectly conformal. These films provide an excellent level of protection of the batteries against the permeation of water and oxygen molecules, so that only at the point where the electrical contacts pass through the encapsulation is permeation of such molecules still possible: it is this point that usually determines the loss of impermeability of the battery.

Metalized films are known and very much used for durably protecting pouch cells from moisture. In general, for a given thickness of material, the metals make it possible to produce very impermeable films, more impermeable than those based on ceramics, and even more impermeable than those based on polymers, which are generally not very hermetic to the passage of water molecules.

In addition, the method for manufacturing such contact units typically requires the use of high heat treatments that may degrade the electronic and/or electrochemical devices comprising them. This is in particular the case with lithium ion batteries provided with porous electrodes and/or electrolytes impregnated with electrolytes based on ionic liquids.

WO 2013/064779 (I-TEN) describes a multilayer lithium-ion battery wherein the electrical contact units have been added at the point where the cathodic and respectively anodic current collectors are visible, i.e. not coated with insulating electrolyte. These electrical contact units serve to take the electrical connections between all the anodes on the one hand and all the cathodes on the other hand of the battery. They electrically connect the surfaces of the anodes and respectively of the cathodes to each other. These electrical contact units are coverings having metallic conductivity. They may be produced in the form of a single metallic layer, tin for example, or consist of multilayers, i.e. consist of a first layer of conductive polymer, such as a resin containing silver, a second layer of nickel and a third layer of tin. In this three-layer complex, the layer of nickel protects the layer of polymer during the steps of assembly by welding, and the layer of tin provides the weldability of the interface of the battery. However, the layers of nickel and tin are often porous and do not completely protect the battery with respect to the atmosphere. Moreover, the silver particles contained in the layer of resin are not inert in the operating voltage ranges of the batteries. Moreover, such a three-layer complex is more expensive to manufacture.

The present invention aims to at least partly remedy some drawbacks of the prior art mentioned above.

It aims in particular to produce electrical contact units that are more efficient at less cost, in particular sealed electrical contact units having a very low water vapor transmission rate in order to improve the service life of the batteries.

It also aims to produce electrical contact units with low internal resistances. It also aims to produce electrical contact units allowing the assembly of electronic and electrochemical devices, such as microbatteries, by welding on electronic circuits. It aims in particular to propose a method that makes it possible to manufacture electrical contact units in a simple, easy to implement, reliable and rapid manner without degrading the performances of the electronic or electrochemical devices comprising them, and electronic or electrochemical devices having a very long service life. It aims in particular to propose a method that reduces the risk of short-circuit, and which makes it possible in particular to manufacture an electrochemical device such as a battery having low self-discharge.

### OBJECTS OF THE INVENTION

At least one of the above objectives is achieved by means of at least one of the objects according to the invention as presented below. The present invention proposes as a first object a contact unit for an electronic or electrochemical device such as a battery, intended to provide the electrical contact with an external conductive element, said electronic or electrochemical device comprising a contact surface defining an electrical contact area, characterized in that the contact unit comprises a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite.

Advantageously, the electrically conducted particles are made from titanium, nitrides or carbon, in particular in the form of carbon black, graphite or graphene.

Advantageously, this contact unit comprises a second layer comprising, preferably consisting of, a metal foil, disposed on the first layer of material filled with electrically conductive particles. This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

Advantageously, this contact unit comprises a third layer comprising pure tin and/or pure zinc and/or a tin-metal alloy wherein the metal is selected from zinc, lead, palladium, gold, copper and a mixture thereof, disposed on the second layer.

Advantageously, this contact unit comprises a fourth layer of pure tin or a fourth layer of an alloy comprising silver, palladium and copper, disposed on the third layer.

Each layer of the contact unit comprising two layers, three layers or four layers, as indicated above, may be implemented with the first object above, and used according to any technically compatible combination, whatever the chemical nature thereof and the chemical nature of the first layer. Some combinations are presented below according to various embodiments.

In another embodiment, the present invention proposes, as another object, a contact unit for an electronic or electrochemical device such as a battery, intended to provide the electrical contact with an external conductive element, said electronic or electrochemical device comprising a contact surface defining an electrical connection area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil, disposed on the first layer of material filled with electrically conductive particles.

This metal foil is preferably selected from aluminum foils, copper foils, titanium foils, molybdenum foils, stainless-steel foils and foils comprising metallic copper. The second layer preferably has a thickness of less than 20 μm, preferably a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical connection area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure tin, disposed on the second layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure zinc, disposed on the second layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising a tin-metal alloy, disposed on the second layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure tin, disposed on the second layer,
a fourth layer of pure tin, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure zinc, disposed on the second layer,
a fourth layer of pure tin, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising a tin-metal alloy, disposed on the second layer,
a fourth layer of pure tin, disposed on the third layer.

Advantageously, the metal of the tin-metal alloy is selected from zinc, lead, palladium, gold, copper and a mixture thereof.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure tin, disposed on the second layer,
a fourth layer of an alloy comprising silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure zinc, disposed on the second layer,
a fourth layer of an alloy comprising silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising a tin-metal alloy, disposed on the second layer,
a fourth layer of an alloy comprising silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention used for putting the anodes and cathodes in contact, may be different.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure tin, disposed on the second layer,
a fourth layer of an alloy consisting of silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising pure zinc, disposed on the second layer,
a fourth layer of an alloy consisting of silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention used, for putting the anodes and cathodes in contact, may be different.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising, preferably consisting of, a metal foil disposed on the first layer of material filled with electrically conductive particles,
a third layer comprising a tin-metal alloy, disposed on the second layer,
a fourth layer of an alloy consisting of silver, palladium and copper, disposed on the third layer.

This metal foil is preferably selected from aluminum foils, copper foils, titanium foils, molybdenum foils, stainless-steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure tin, disposed on the second layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure zinc, disposed on the second layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising a tin-metal alloy, disposed on the second layer.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure tin, disposed on the second layer,
a fourth layer of pure tin, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure zinc, disposed on the second layer,
a fourth layer of pure tin, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising a tin-metal alloy, disposed on the second layer,
a fourth layer of pure tin, disposed on the third layer.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure tin, disposed on the second layer,
a fourth layer of an alloy comprising silver, palladium and copper, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure zinc, disposed on the second layer,
a fourth layer of an alloy comprising silver, palladium and copper, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising a tin-metal alloy, disposed on the second layer,
a fourth layer of an alloy comprising silver, palladium and copper, disposed on the third layer.

Advantageously, the metal of the tin-metal alloy is selected from zinc, lead, palladium, gold, copper and a mixture thereof.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure tin, disposed on the second layer,
a fourth layer of an alloy consisting of silver, palladium and copper, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising pure zinc, disposed on the second layer,
a fourth layer of an alloy consisting of silver, palladium and copper, disposed on the third layer.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer comprising metallic copper, disposed on the first layer of material filled with electrically conductive particles,
a third layer comprising a tin-metal alloy, disposed on the second layer,
a fourth layer of an alloy consisting of silver, palladium and copper, disposed on the third layer.

Advantageously, the metal of the tin-metal alloy is selected from zinc, lead, palladium, gold, copper and a mixture thereof.

Another object of the invention is an electronic or electrochemical device including at least one contact unit according to the invention, the electronic or electrochemical device preferably being chosen from a capacitor, a battery or a lithium ion battery.

Another object of the invention is a method for manufacturing at least one contact unit of an electronic or electrochemical device such as a battery, comprising:

a. providing an electronic or electrochemical device, said electronic or electrochemical device comprising a contact surface defining an electrical connection area,

b. depositing on at least the electrical connection area, preferably on at least the contact surface, a first layer of material filled with electrically conductive particles, preferably said first layer being formed by a polymer resin and/or a material obtained by a sol-gel process filled with electrically conductive particles.

Advantageously, this method comprises after step b), when said first layer is formed from polymer resin and/or a material obtained by a sol-gel process filled with electrically conductive particles, a drying step followed by a step of polymerizing said polymer resin and/or said material obtained by a sol-gel process.

Advantageously, this method comprises, after step b) or after the polymerization step, the following steps:

c. depositing, on the first layer, a metal foil, or an ink preferably including a metal, preferentially copper in the form of organocopper compounds or particles, preferably copper nanoparticles,

d. heat treating at least the second layer deposited in order to obtain a conductive layer.

The metal foil is preferably selected from aluminum foils, copper foils, titanium foils, molybdenum foils, stainless-steel foils and foils comprising metallic copper. The second layer preferably has a thickness of less than 20 μm, preferably a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

When an ink is deposited on the first layer, it is advantageously deposited by dipping.

Advantageously, this method comprises, after step d), on at least the electrical connection area of the electronic or electrochemical device, coated with the first and the second layer, a step e) of depositing pure tin and/or zinc and/or a tin-metal alloy wherein the metal is selected from zinc, lead, palladium, gold, copper and a mixture thereof, on the understanding that preferably the pure tin and/or of zinc is deposited by electrodeposition and that preferably said tin-metal alloy is deposited by dipping in a molten bath of said tin-metal alloy.

Advantageously, this method comprises, after the step e), on at least the electrical connection area of the electronic or electrochemical device, coated with the first, with the second layer and with the third layer, a step f) of depositing a layer of pure tin by electrodeposition or of a layer of an alloy comprising silver, palladium and copper.

In another embodiment, the present invention proposes as another object a contact unit for an electronic or electrochemical device such as a battery, intended to provide the electrical contact with an external conductive element, said electronic or electrochemical device comprising a contact surface defining an electrical contact area, characterized in that the contact unit comprises:
a first layer, disposed on at least the electrical connection area, this first layer comprising a material filled with electrically conductive particles, preferably a polymer resin and/or a material obtained by a sol-gel process, filled with electrically conductive particles, and even more preferentially a polymer resin filled with graphite,
a second layer of conductive polymer disposed on the first layer, such as a layer of epoxy resin filled with silver,
a third layer of nickel disposed on the second layer, and
a fourth layer of tin disposed on the third layer.

### DESCRIPTION OF THE FIGURES

Certain aspects of the invention and embodiments of the invention are illustrated, with reference to the accompanying figures, given solely by way of non-limitative examples, wherein:

FIG. 1A, FIG. 1B, FIG. 1C and FIG. 1D show schematically a contact unit disposed on an electrical contact area according to four variants of the invention.

FIG. 1A illustrates the internal structure of various elements constituting a contact unit according to the first variant of the invention.

FIG. 1B illustrates the internal structure of various elements constituting a contact unit according to the second variant of the invention.

FIG. 1C illustrates the internal structure of various elements constituting a contact unit according to the third variant of the invention.

FIG. 1D illustrates the internal structure of various elements constituting a contact unit according to the fourth variant of the invention.

FIG. 2 shows schematically a battery showing a central element and two contact units disposed at the two ends of the central element.

FIG. 3 shows schematically a front view with cutaway along the line of a battery, showing the internal structure of the central element comprising an assembly of elementary cells covered by an encapsulation system and the internal structure of the contact units according to the invention.

FIG. 4 shows an exploded perspective view of the stack of thin anode and cathode layers, so that these layers are offset laterally.

FIG. 5A shows a view at the output of the anode showing electrical connection areas, i.e. the anodic current collectors surrounded on the periphery thereof by the encapsulation system.

FIG. 5B shows a view at the output of the cathode showing electrical connection areas, i.e. the cathodic current collectors surrounded on the periphery thereof by the encapsulation system.

FIG. 6A, FIG. 6B, FIG. 6C and FIG. 6D show schematically a front view with cutaway of a battery similar to FIG. 3.

FIG. 6A illustrates the internal structure of various elements constituting a contact unit according to the first variant of the invention.

FIG. 6B illustrates the internal structure of various elements constituting a contact unit according to the second variant of the invention.

FIG. 6C illustrates the internal structure of various elements constituting a contact unit according to the third variant of the invention.

FIG. 6D illustrates the internal structure of various elements constituting a contact unit according to the fourth variant of the invention.

### LIST OF REFERENCES USED ON THE FIGURES

TABLE 1

| | |
|---|---|
| 1 | Battery |
| 2 | Elementary cell |
| 10 | Anode |
| 11 | Layer of a conductive substrate |
| 12 | Layer of an active anode material |
| 13 | Layer of an electrolyte material |
| 20 | Cathode |
| 21 | Layer of a conductive substrate |
| 22 | Layer of an active cathode material |
| 23 | Thin layer of an electrolyte material |
| 30 | Encapsulation system |
| RS | Projecting region |
| RR | Recessed region |
| 40 | Contact unit according to the invention |
| 41 | First layer of the contact unit 40 according to the invention |
| 42 | Second layer of the contact unit 40 according to the 2nd, 3rd or 4th |
| | variant of the invention |
| 43 | Third layer of the contact unit 40 according to the 3rd or 4th variant |
| | of the invention |
| 44 | Fourth layer of the contact unit 40 according to the 4th variant of the |
| | invention |
| 50 | Electrical contact area |
| 51 | Contact surface |
| III- | Axis |
| III | |

### DESCRIPTION OF THE INVENTION

### Definitions

Unless mentioned to the contrary, the concept of “conductivity” used here refers to electrical conductivity.

“Ink” means any fluid composition that can be applied to a support and giving after solidification treatment a solid conductive layer; an ink may in particular be a suspension or a solution. The treatment of an ink making it possible to obtain a conductive layer may in particular be a drying, a polymerization or a heat treatment such as a sintering.

Epoxy resin means a resin comprising at least one polyepoxide polymer.

### DETAILED DESCRIPTION OF THE INVENTION

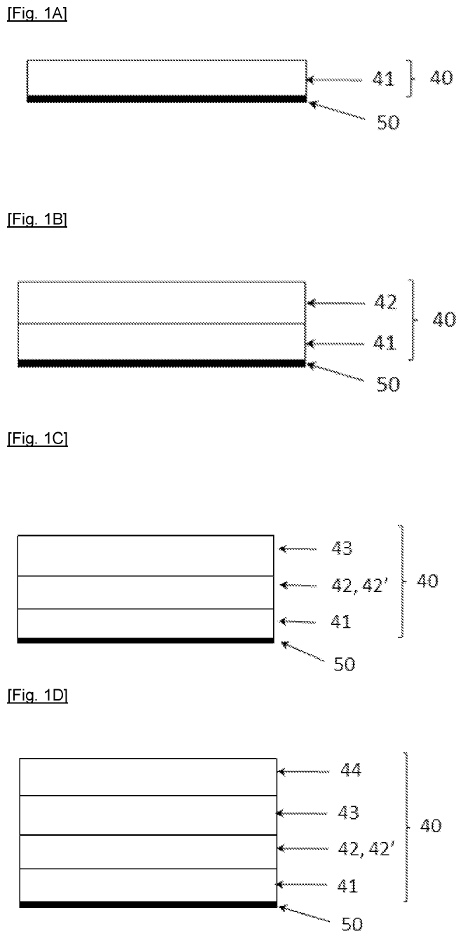

The electrical contact units 40 of an electronic or electrochemical device such as a battery 1, according to the invention, are disposed on at least one electrical connection area 50 of said electronic or electrochemical device, as illustrated in figures LA, 1B, 1C and 1D. FIGS. 1A, 1B, 1C and 1D illustrate the internal structure of various elements constituting a contact unit according respectively to the first, the second, the third and/or the fourth embodiment of the invention where the various layers constituting the contact unit, apart from the electrically conductive role thereof, each have a particular function.

The contact units described below can be implemented on electronic or electrochemical devices, insofar as this is possible for or can be envisaged by a person skilled in the art. These contact units are added to the electronic or electrochemical devices to establish the electrical contacts necessary for the correct functioning of said devices. These contact units can advantageously be used for establishing the electrical contacts necessary for the correct functioning of the batteries comprising dense or porous electrodes impregnated with a liquid electrolyte as well as batteries comprising solid electrolytes.

The structure of the contact units 40 of an electronic or electrochemical device will now be described according to the four embodiments of the invention, in particular, by way of non-limitative example, the structure of the contact units 40 according to the invention of a battery 1 such as a lithium ion battery.

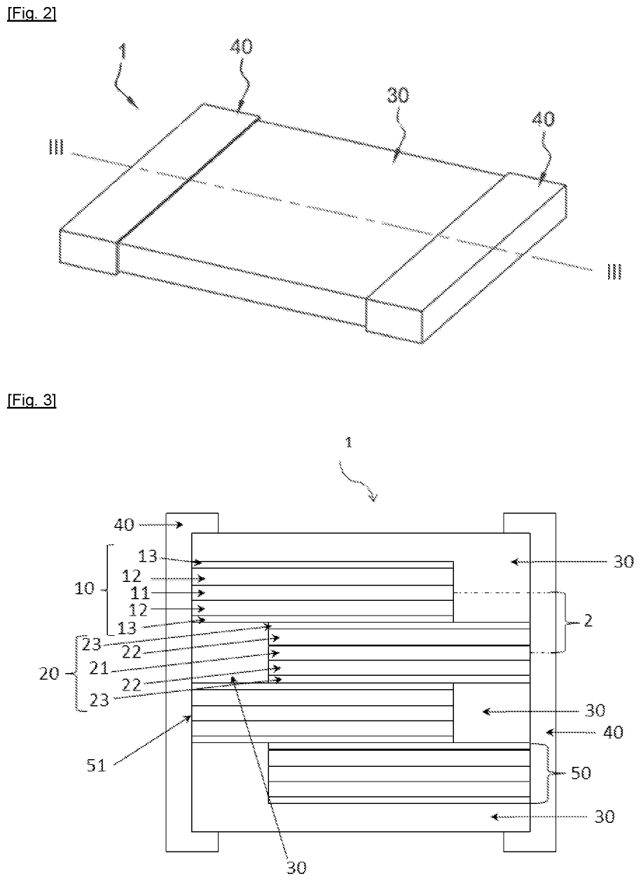

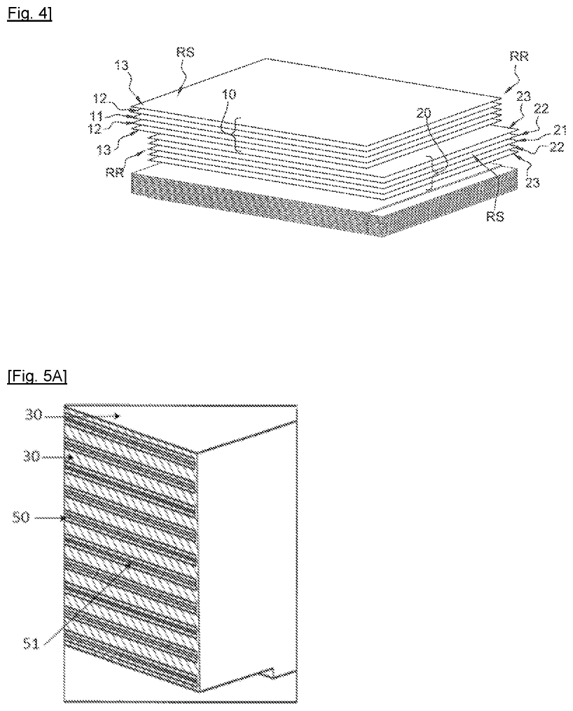

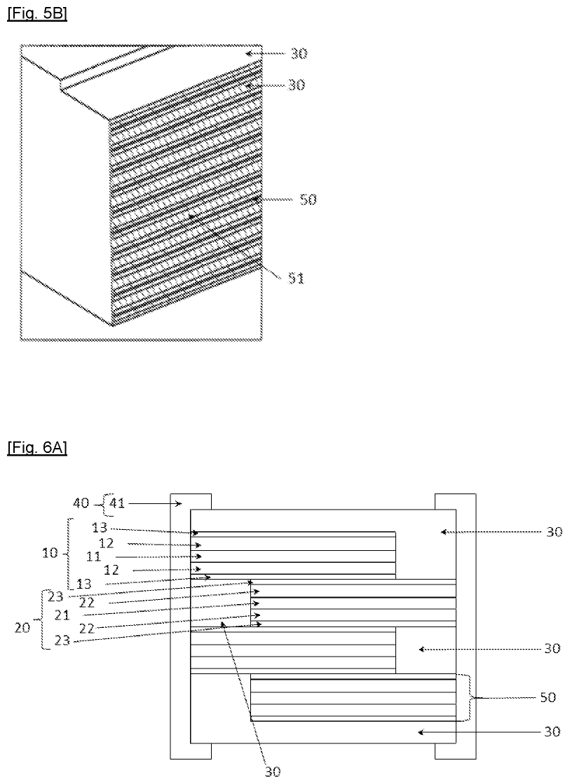

The batteries 1 have a central structure on which it is possible to deposit an encapsulation system 30 and contact members according to the invention 40 (cf. FIG. 2). FIG. 3 is a front view with cutaway of a battery 1 showing the internal structure of the central element comprising an assembly of elementary cells 2 covered by an encapsulation system 30 and the internal structure of the contact members 40 according to the invention. Each elementary cell comprises an anode 10 and a cathode 20, each consisting of a stack of thin layers. The anode comprises successively a thin layer of an electrolyte material 13, a thin layer of an active anode material 12 such as Li₄Ti₅O₁₂, a thin metallic layer 11 (for example made from stainless steel), a thin layer of an active anode material 12 such as Li₄Ti₅O₁₂, and a thin layer of an electrolyte material 13. The cathode 20 comprises successively a thin layer of an electrolyte material 23, a thin layer of an active cathode material 22 such as LiMn₂O₄, a thin metallic layer 21 (for example made from stainless steel), a thin layer of an active cathode material 22 such as LiMn₂O₄, and a thin layer of an electrolyte material 23, on the understanding that the battery comprises an alternating succession of at least one anode 10 and at least one cathode 20, two adjacent sheets of which define at least one projecting region RS, intended to form an accessible connection area, and at least one recessed region RR intended to form a covering area, i.e. an area covered by the encapsulation system 30, as illustrated in FIG. 4.

After the step of stacking the thin layers constituting the elementary cells 2 (cf. FIG. 4), the stack can be encapsulated in an encapsulation system 30 for providing the protection of the battery with respect to the atmosphere. The quality of the encapsulation is of prime importance for lithium ion batteries. The encapsulation system 30 is chemically stable, withstands a high temperature, offers protection against moisture and is impermeable to the atmosphere in order to fulfill its function of barrier layer. It may consist of a plurality of layers, not shown, deposited successively on the stack, in particular on the parts of the object requiring to be protected. This encapsulation system allows electrical insulation and sealing of the electronic components or batteries while ensuring the possibility of subsequently being able to connect them electrically to each other and/or to external connection points.

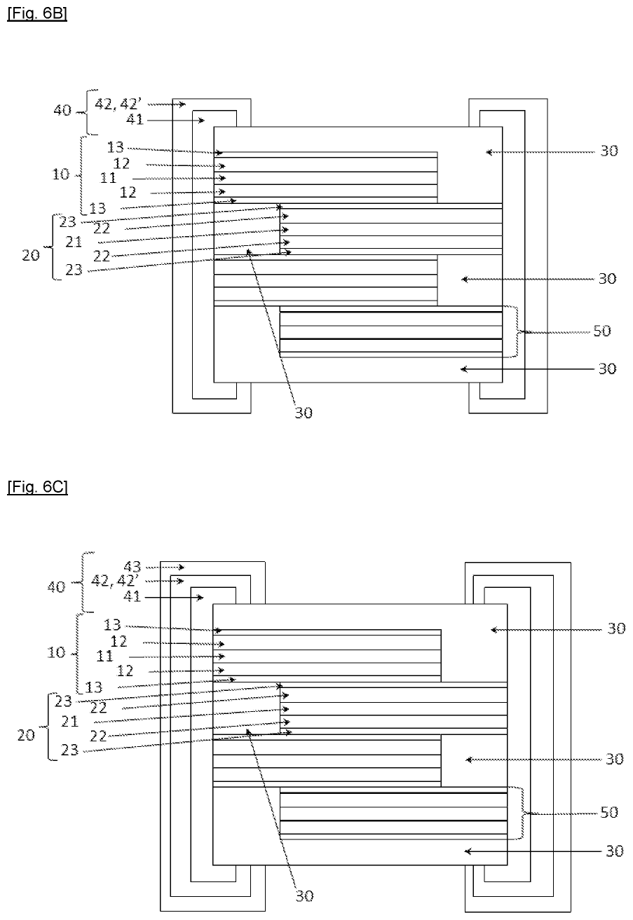

As illustrated in FIGS. 5A and 5B, before depositing the contact units 40, the stack coated by the encapsulation system 30 is cut along cutting planes making it possible to obtain a unitary battery, with the baring on each of the cutting planes of the (+) and (−) connections of the battery, in particular in the projecting regions, so that the encapsulation system covers four of the six faces of said battery, preferably continuously, so that the system can be assembled without welding, the other two faces of the battery subsequently being covered by the contact units 40. Advantageously, the battery comprises contact units 40 at the point where the cathode and respectively anode current collectors are visible. Preferably, the anodic electrical connection areas 50 and the cathodic electrical connection areas 50 are located on the opposite sides of the stack (cf. FIGS. 5A and 5B). On and preferably around these electrical connection areas the contact units 40 according to the invention are deposited.

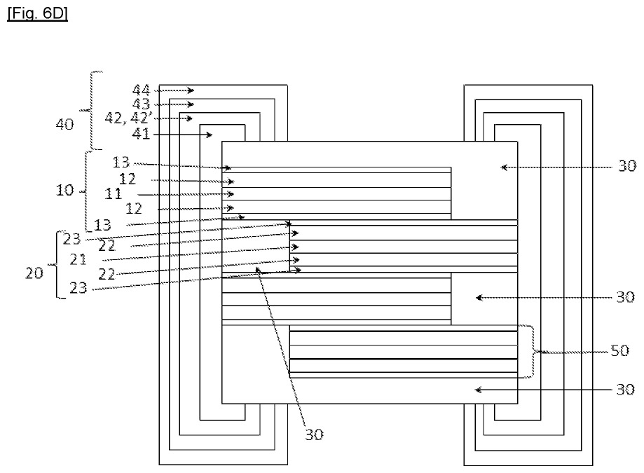

We now describe, in relation to figure LA, FIG. 1B, FIG. 1C, FIG. 1D, FIG. 6A, FIG. 6B, FIG. 6C and FIG. 6D, five embodiments of the contact units according to the invention.

### Electrical Contact Units According to the First Embodiment of the Invention

The electrical contact units 40 of an electronic or electrochemical device such as a battery 1 according to the invention comprise a first layer 41, which comprises a material filled with electrically conductive particles. This material is advantageously inert with respect to the electrochemical reactions taking place in said electronic or electrochemical device. For an electrochemical device, this material is advantageously inert at the operating potentials of the electrodes of said device. This material is preferably a polymer resin (preferentially an epoxy resin) and/or a material obtained by a sol-gel process filled with electrically conductive particles and advantageously inert with respect to the electrochemical reactions taking place in said device. This material is deposited on at least one electrical connection area 50 of the electronic or electrochemical device as illustrated in figure LA.

In the case where the device is an electrochemical device, for the materials involved in the composition or structure of the electrical contact unit according to the invention, materials are advantageously selected that are inert with respect to the electrochemical reactions taking place in said device.

The electrically conductive particles that are inert with respect to the electrochemical reactions taking place in said electronic or electrochemical device are preferably made from carbon, in particular in the form of carbon black, graphite or graphene, or made from titanium, or nitrides. In order to minimize the contact resistances, the carbon content in the suspensions or inks used to produce this first layer is preferably greater than 15% by mass.

The polymer resin may be an epoxy resin. The polymer resin may advantageously be a polyepoxide obtained from at least one polymerizable precursor material, preferably a polyepoxide obtained from at least one photopolymerizable precursor material. Advantageously, when the polymer resin is an epoxy resin, the carbon content in the suspensions or inks used is greater than 15% by mass carbon black.

The material obtained by a sol-gel process may be silica.

The polymer resin (preferentially an epoxy resin) and/or the material obtained by a sol-gel process must also be compatible with the techniques used for producing the electronic or electrochemical devices, such as heat treatments. By way of example, in the case of lithium ion batteries, the polymer resin (preferentially an epoxy resin) and/or the material obtained by a sol-gel process must be chemically compatible with lithium and compatible with the steps of manufacturing such a battery in order to avoid any degradation of its properties. The polymer resin (preferentially an epoxy resin) and/or the material obtained by a sol-gel process must be an element that is stable both from a chemical point of view and from a thermal point of view.

The carbon may be introduced into the polymer resin and/or the material obtained by a sol-gel process in the form of nanoparticles and/or in any other form.

The layer 41 of material filled with particles that are electrically conductive and advantageously inert with respect to the electrochemical reactions taking place in said electronic or electrochemical device, such as a battery 1, is conductive. Advantageously it is flexible, so as to be able to absorb any deformations undergone by the electronic or electrochemical device such as a battery 1, in particular when it is welded to an electronic circuit. By virtue of the flexibility thereof, this layer does not risk rupturing at the interfaces in the event of mechanical stressing.

Furthermore, when the device is an electrochemical device comprising insertion materials, the latter, even if they are considered to be dimensionally stable, always deform a little according to the degree of insertion thereof. This is in particular the case with lithium ion batteries 1 including lithium insertion materials. Thus the layer 41 of material filled with electrically conductive particles safeguards the electrical contacts by absorbing the deformations, in particular during the steps of insertion and disinsertion of the electrode materials. The particles, which are electrically conductive and based on carbon, in particular the graphite present in the layer of material filled with electrically conductive particles, provide good conduction at the electrical contacts without degrading the performance of the device, unlike the epoxy resins filled with silver of the prior art, which are not deformable.

Moreover, carbon, in particular in the form of carbon black or graphite, is less expensive than silver or other noble metals, and replacing the latter with carbon, in particular in the form of carbon black or graphite, has an economic advantage.

The layer of material filled with electrically conductive particles, preferably polymer resin filled with carbon, advantageously has a thickness of between 5 μm and 50 μm. Advantageously, this first layer 41 has a thickness of less than 50 μm so as to minimize the resistivity thereof: the thinner this first layer 41, the less resistive it is. Advantageously, this first layer 41 has a minimum thickness of 5 μm; this makes it possible firstly to provide good electrical contact between all the layers of electrodes of the electronic or electrochemical device, such as a battery, and secondly makes it possible to make up for any alignment or positioning defects that may exist between the electrodes.

By way of example, when the electrodes are based on Li₄Ti₅O₁₂, the polymer resin and/or the material obtained by a sol-gel process is preferentially filled with carbon; the carbon is inert at the operating potentials of the anodes based on Li₄Ti₅O₁₂. This carbon may be carbon black, graphite or graphene. The carbon may be introduced, into the polymer resin and/or the material obtained by a sol-gel process, in the form of nanoparticles and/or in any other form.

The method making it possible to obtain such an electrical contact unit 40, in accordance with the first embodiment of the invention, comprises first of all:

a. providing an electronic or electrochemical device, said device comprising a contact surface 51 defining an electrical connection area 50,

b. depositing, by any suitable means, a first layer 41 of material filled with electrically conductive particles, preferably a polymer resin and/or a material obtained by a sol-gel process filled with electrically conductive particles, on at least said electrical connection area 50, preferably on at least the contact surface 51, on the understanding that preferably this deposition slightly projects over the ends of the contact surface, so as to completely cover the electrical connection area 50, preferably the contact surface 51, and thus guaranteeing optimal protection of the device such as a battery, as illustrated in FIG. 6A, by way of example.

The layer 41 of material filled with electrically conductive particles, preferably material filled with graphite, preferably polymer resin filled with graphite, can be deposited by any suitable means, in particular by dipping. This layer 41 is preferably dried and, when the material filled with electrically conductive particles is a polymer resin and/or a material obtained by a sol-gel process, this layer is advantageously polymerized before any other subsequent deposition.

### Electrical Contact Units According to the Second Embodiment of the Invention

In this second embodiment, the first layer is deposited as indicated previously in the first embodiment, and for the same purpose.

Advantageously, the electrical contact units 40 of an electronic or electrochemical device comprise a second layer 42 that comprises metallic copper deposited on the first layer 41 or a second layer 42′ consisting of a metal foil deposited on the first layer 41. This metal foil is preferably chosen from aluminum foils, copper foils, titanium foils, molybdenum foils, stainless steel foils and foils comprising metallic copper. Advantageously, this metal foil has a thickness of less than 20 μm, preferably a thickness of less than 10 μm, more preferentially around 5 μm, and even more preferentially less than 5 μm. The metal of the metal foil may be an alloy such as stainless steel or a pure metal such as copper, aluminum, titanium or molybdenum.

The natures of the metal foils, of the contact units according to the invention, used to put the anodes and cathodes in contact, may be different.

Said first layer 41 typically comprises a material filled with electrically conductive particles, preferably polymer resin and/or a material obtained by a sol-gel process filled with electrically conductive particles (cf. FIGS. 1B and 6B).

This second layer 42, 42′ fulfills two functions: firstly it provides the impermeability of the structure, i.e. prevents the migration of water inside the device, and secondly it protects said first layer 41 from the atmosphere, particularly from the air and moisture. Thus this second layer 42, 42′ avoids degradation of the structure and improves the service life of the electronic or electrochemical device. Furthermore, when the electronic or electrochemical device is integrated in an electronic chip, better known by the expression “integrated circuit”, the second layer 42 comprising metallic copper facilitates the connections between the various components of the integrated circuit, and ultimately facilitates implementation thereof.

The method for obtaining such electrical contact units 40 according to the invention comprises first of all:

a. providing an electronic or electrochemical device, said device comprising a contact surface 51 defining an electrical connection area 50,

b. depositing, by any suitable means, a first layer of material filled with electrically conductive particles, preferably a polymer resin and/or a material obtained by a sol-gel process filled with electrically conductive particles, on at least said electrical connection area 50, preferably on at least the contact surface 51, on the understanding that preferably this deposition slightly projects over the ends of the contact surface, so as to completely cover the electrical connection area 50, preferably the contact surface 51, and thus guaranteeing optimal protection of the device (cf. FIGS. 5A and 5B),

c. depositing, by any suitable means, on said first layer 41, a metal foil, or an ink including copper in the form of organocopper compounds or particles, preferably copper nanoparticles, and

d. heat treating at least the second layer deposited in order to obtain a conductive layer 42, 42′.

This metal foil is preferably selected from aluminum foils, copper foils, titanium foils, molybdenum foils, stainless steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used to put the anodes and cathodes in contact, may be different.

When an ink is deposited on the first layer, it is advantageously deposited by dipping.

When the second layer is obtained, by depositing, by any suitable means, a metal foil, the heat treatment of at least the second deposited layer facilitates adhesion between the first layer and the second layer, i.e. facilitates adhesion between the electrical connection areas (anodic and cathodic) and the second layer and makes it possible to obtain a conductive layer 42′ secured to the first layer.

Secured means that, under normal conditions of use, the first layer and the second layer are attached to each other without any degree of freedom.

The conductive layer 42′ advantageously has a thickness of between 1 μm and 50 μm and preferably between 3 μm and 20 μm, independently of the variant embodiments according to the invention. A thickness of 1 μm is sufficient to ensure impermeability of the electronic or electrochemical device such as a battery 1.

When the second layer is obtained using an ink including copper in the form of organocopper compounds and particles, preferably copper nanoparticles, the heat treatment of at least the second layer deposited makes it possible to obtain a layer of conductive metallic copper 42 free from organic compounds.

The layer of metallic copper 42 advantageously has a thickness of between 1 μm and 50 μm and preferably between 3 μm and 20 μm, independently of the variant embodiments according to the invention. A thickness of 1 μm is sufficient to ensure impermeability of the electronic or electrochemical device such as a battery 1.

The deposition, on the first layer 41, of an ink including copper in the form of organocopper compounds and copper particles, preferably copper nanoparticles, can be implemented by any suitable means, preferably by dipping.

The layer of copper 42 may in particular be deposited electrochemically, however this technique requires dipping the electrical connection area covered with a material filled with electrically conductive particles, preferably covered with polymer resin and/or a material obtained by a sol-gel process loaded in an aqueous bath. Since this electrical contact is not perfectly sealed, it is preferable not to use such techniques in order not to degrade the performance of the electronic or electrochemical device, i.e. of the battery.

For producing a layer of metallic copper 42, deposition techniques based on organic inks are preferred, i.e. solutions comprising organocopper compounds or suspensions comprising copper particles, preferably copper nanoparticles dispersed in an organic solvent.

The organic inks used, including copper in the form of organocopper compounds and copper particles, preferably copper nanoparticles, may be inks identical to those used in printing conductive tracks on polymer supports or used in printed electronics, such as inks containing copper nanoparticles functionalized for example by polyvinylpyrrolidone (PVP). Advantageously, when the ink comprises copper particles, preferably copper nanoparticles, the latter represent between 10% and 85% by mass of the ink. The degree of dilution of the copper particles in the ink will modulate the viscosity of the suspension, which will make it possible to adjust the thickness of the deposition of the second layer. The solvents used for formulating this ink may be organic, in particular ethylene glycol. The mean diameter of the copper particles is of the order of 10 nanometers, preferably between 30 nm and 40 nm.

The heat treatment of the ink deposited on the first layer is a sintering: it aims to increase the density of at least the second deposited layer including copper nanoparticles. It may be implemented by the flash sintering technique (known by the English expression “flash light sintering”), in particular by sintering under a pulsed xenon lamp. This layer 42 however includes insulating organic materials that must be eliminated by heat treatment. The heat treatment leads to the decomposition of the organic compounds of the suspensions or inks, which leave in the vapor phase, so as to leave no more than a deposit of metallic copper. In the same way, when the suspension or the ink contains copper nanoparticles, these heat treatments will also make it possible, as the organic solvents are eliminated, to bind the nanoparticles together, to sinter them at low temperature, and to densify the deposit until a layer of metallic copper is obtained, dense and electrically conductive.

These techniques make it possible to obtain pure copper films at relatively low temperature, the compactness of which varies according to the sintering duration and temperature conditions.

Advantageously, the layers deposited are densified, in order to minimize the presence of cavities, pores, cracks and other compactness defects. This densification step can be implemented by heat treatment and/or by irradiation under a xenon lamp. The optimal temperature depends greatly on the chemical composition of the suspensions, inks, resins and powders deposited. Advantageously, the sintering is implemented at a temperature not exceeding 300° C. In some embodiments, it does not exceed 200° C.

Moreover, the inventor has found that, the more the size of the copper particles deposited decreases, the more the temperature of the heat treatment can be reduced. It is thus possible to produce deposits in thin layers with a degree of porosity of less than 5% or even less than 2%, without having recourse to high temperatures and/or a long heat treatment. When the suspensions or inks used contain copper nanoparticles, this makes it possible to reduce the temperatures and durations of sintering, which are situated at around 200-300° C. for obtaining an almost completely densified layer, i.e. a layer having a degree of porosity of less than or equal to 5%.

For particle sizes such as those used in the method according to the invention, namely of the order of 10 nanometers, preferably between 30 nm and 40 nm, it is the increase in the surface energy that becomes the main motive force of the densification by heat treatment; this results in the fact that, when the size of the particles decreases, the thermal densification begins at a significantly lower temperature. The presence of conglomerates and interconglomerate cavities also influences the densification, and thus it is important for the suspensions or inks to be stable, preferably to contain stabilizers for avoiding phenomena of conglomeration.

According to the invention, at least one of the layers deposited is densified, and preferably all the layers deposited. Highly advantageously, when the second layer 42 includes copper nanoparticles, the densification step is implemented after the deposition of this second layer (before the deposition of a new layer), by sintering, preferably by irradiation with UV lamps, in order to obtain a layer of metallic copper of good quality, provided with low internal resistance, as well as good bonding between the first and second layers.

Apart from the fact of being electrically very conductive, the layer of metallic copper creates a bonding surface propitious to the deposition of other layers by immersion in a bath of metal or molten alloy, and this even if the layer of metallic copper is not 100% consolidated. This is because alloys based on tin and/or zinc wet copper surfaces well.

### Electrical Contact Units According to the Third Embodiment of the Invention

In a third embodiment, the electrical contact units of an electronic or electrochemical device according to the invention comprise:
a first layer 41 of material filled with electrically conductive particles, preferably a polymer resin and/or a material obtained by a sol-gel process filled with electrically conductive particles, and even more preferentially epoxy resin filled with electrically conductive particles, deposited on at least one electrical connection area of the electronic or electrochemical device, preferably on at least one contact surface defining said electrical connection area, so as to completely cover the electrical connection area, preferably the contact surface, and thus guaranteeing optimal protection of the device,
a second layer 42′ consisting of a metal foil, preferably chosen from aluminum foils and stainless steel foils, or comprising metallic copper, deposited on the first layer of material filled with electrically conductive particles,
a third layer 43 comprising pure tin and/or pure zinc and/or a tin-metal alloy wherein the metal is chosen from zinc, lead, palladium, gold, copper and a mixture thereof, said third layer being deposited on said second layer (cf. FIGS. 1C and 6C).

This metal foil is preferably selected from aluminum foils, copper foils, titanium foils, molybdenum foils, stainless steel foils and foils comprising metallic copper. The second layer preferably has a thickness of less than 20 μm, and even more preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

The second layer comprising metallic copper can be obtained by depositing an ink. When an ink is deposited on the first layer, it is advantageously deposited by dipping.

In this third embodiment, the first and second layers are deposited as indicated before in the second embodiment, and for the same purpose. The third layer 43 comprises pure tin and/or pure zinc and/or a tin-metal alloy wherein the metal is selected from zinc, lead, palladium, gold, copper and a mixture thereof. Said tin-metal alloy is deposited by any suitable means on said second layer, preferably by dipping in a molten alloy bath.

The good wetting properties of these molten metals and alloys on copper ensures the perfect making good of all the defects and provides this low WVTR. The permeance to water vapor (WVTR) can be measured by means of a method that is the subject of U.S. Pat. No. 7,624,621 and which is also described in the publication “Structural properties of ultraviolet cured polysilazane gas barrier layers on polymer substrates” by A. Mortier et al., which appeared in the journal Thin Solid Films 6+550 (2014) 85-89.

Moreover, the chemical composition of the alloy deposited by immersion in the molten bath is defined so that the melting point of the alloy is as low as possible but always greater than 250° C. to guarantee the compatibility and integrity of this metal protective layer during the subsequent welding-remelting steps, called solder-reflow in English.

The layers obtained by immersion in a molten metal bath are deemed to be completely dense, metallic and completely impervious with regard to permeation to water molecules. Thus this third metal layer 43 ensures complete sealing of the battery. Any potential defects present in the metallic copper layer 42 are then repaired by the production of this third layer by immersion in the molten metal bath, by galvanization or by tinning or hot dip tinning.

This third layer 43 provides the impermeability of the device as well as the weldability thereof.

This method has numerous advantages. Said third layer is deposited by a simple rapid method that is easy to implement. It is no longer necessary to use methods such as atomic layer deposition (ALD) or vacuum deposition methods to obtain good impermeability of the electrical contact units and of the structure of the device.

The third layer 43 preferably comprises low melting point alloys, ideally these alloys are designed to have a melting point of between 280 and 320° C. so as not to impair the battery and to remain solid during the steps of assembly by reflow; the welding by reflow of the electronic components taking place at 260° C. By way of example, Sn/Zn alloys are preferred, wherein the Zn content would be situated at around 40%±10% by mass, which makes it possible to obtain a melting point of around 300° C., i.e. a melting point higher than that of the pure tin used for assemblings by reflow (232° C.)

Moreover, the tin-metal alloy (such as tin-zinc alloy) wets and perfectly covers the copper present in the second layer 42. After cooling, this third layer is dense, i.e. free from pores.

### Electrical Contact Units According to the Fourth Embodiment of the Invention

In a fourth embodiment, the electrical contact units of an electronic or electrochemical device such as a battery according to the invention comprise:
a first layer 41 of material filled with electrically conductive particles that are inert with respect to the electrochemical reactions taking place in the battery, preferably a polymer resin and/or a material obtained by a sol-gel process filled with electrically conductive particles inert with respect to the electrochemical reactions taking place in the battery, and even more preferentially epoxy resin filled with electrically conductive particles inert with respect to the electrochemical reactions taking place in the battery, deposited on at least one electrical connection area of the electronic or electrochemical device, preferably on at least one contact surface defining said electrical connection area, so as to completely cover the electrical connection area, preferably the contact surface, and thus guaranteeing optimal protection of the device,
a second layer 42, 42′ consisting of a metal foil or comprising metallic copper deposited on the first layer,
a third layer 43 comprising pure tin and/or pure zinc and/or a tin-metal alloy wherein the metal is selected from zinc, lead, palladium, gold, copper and a mixture thereof, deposited on the second layer, and
a fourth layer 44 of pure tin or a fourth layer of an alloy comprising, preferably containing, silver, palladium and copper, deposited on the third layer (cf. FIGS. 1D and 6D).

The metal foil of the second layer is preferably selected from aluminum foils, copper foils, titanium foils, molybdenum foils, stainless steel foils and foils comprising metallic copper. The second layer preferably has a thickness of less than 20 μm, preferentially a thickness of less than 10 μm. The metal of the metal foil may be an alloy such as stainless steel or a pure metal such as copper, aluminum, titanium or molybdenum.

The natures of the metal foils, of the contact units according to the invention, used for putting the anodes and cathodes in contact, may be different.

In this fourth embodiment, the first, second and third layers are deposited as indicated previously in the first, the second and the third embodiment and for the same purpose. The fourth layer 44 of pure tin or the fourth layer of an alloy comprising, preferably containing, silver, palladium and copper, is deposited, by any suitable means, on the third layer.

The pure metals such as tin are preferably deposited by electrodeposition.

This fourth layer guarantees the quality of the connection of the electrical contact units by a simple rapid method that is easy to implement, and reduces the contact resistances while conferring good weldability of the electrical contact units. According to the chemical composition of this fourth layer, the latter advantageously ensures only slight oxidation of the contacts.

These third and fourth layers confer on the electrical contact units a very long service life. When the fourth layer comprises an alloy comprising, preferably containing, silver, palladium and copper, this alloy does not oxidize, unlike tin, and thus confers on the electrical contact units better performance over time.

The electronic or electrochemical device comprising at least one such contact unit has a very long service life.

### Electrical Contact Units According to a Fifth Embodiment of the Invention

In this fifth embodiment, the first layer is deposited as indicated previously in the first embodiment, and for the same purpose.

Advantageously and in this fifth embodiment, the electrical contact units 40 of an electronic or electrochemical device consist of multilayers, i.e. consist of a first layer 41, a second layer of conductive polymer disposed on the first layer, such as an epoxy resin filled with silver, a third layer of nickel disposed on the second layer and a fourth layer of tin disposed on the third layer.

Said first layer 41 typically comprises a material filled with electrically conductive particles, preferably polymer resin and/or a material obtained by a sol-gel process filled with electrically conductive particles. This first layer makes it possible to avoid the insertion of lithium in the second layer of conductive polymer, such as a resin filled with silver.

The second conductive polymer, preferably an epoxy resin filled with silver, makes it possible to procure “flexibility” for the connection without breaking the electrical contact when the electrical circuit is subjected to thermal and/or vibratory stresses. The layer of nickel protects the layer of polymer during the steps of assembly by welding, and the layer of tin provides the weldability of the interface of the battery.

The battery according to the invention may be a lithium ion microbattery, a lithium ion minibattery, or a high-power lithium ion battery. In particular, it may be designed and sized so as to have a capacity of less than or equal to approximately 1 mAh (normally referred to as a “microbattery”), so as to have a power greater than approximately 1 mAh up to approximately 1 Ah (normally referred to as a “minibattery”), or so as to have a capacity greater than approximately 1 Ah (normally referred to as a “power battery”). Typically, microbatteries are designed so as to be compatible with the manufacturing methods in microelectronics.

The batteries of each of these three power ranges can be produced:
either with layers of the “completely solid” type, i.e. with no impregnated liquid or viscous phases (said liquid or viscous phases being able to be a medium conductive of lithium ions, capable of acting as an electrolyte),
or with mesoporous layers of the “completely solid type, impregnated with a liquid or viscous phase, typically a medium conductive of lithium ions, which spontaneously enters inside the layer and which no longer emerges from this layer, so that this layer can be considered to be almost solid,
or with impregnated porous layers (i.e. layers having a lattice of open pores that can be impregnated with a liquid or viscous phase, and which confers moist properties on these layers).

### EXAMPLE

The method according to the invention can be implemented in the following manner, in the context of the manufacture of a battery, in particular of the contact units thereof.

### Example 1: Manufacture of a Battery 1 Using Electrical Contact Units 40 According to the Invention

a. Production of an Anode Based on Li₄Ti₅O₁₂

Nanoparticles of Li₄Ti₅O₁₂ are prepared as an anode material by grinding so as to obtain a particle size of less than 100 nm. The nanoparticles of Li₄Ti₅O₁₂ are next dispersed in absolute ethanol at 10 g/l with a few ppm of citric acid in order to obtain a suspension of nanoparticles of Li₄Ti₅O₁₂.

The negative electrodes were prepared by electrophoretic deposition of the nanoparticles of Li₄Ti₅O₁₂ contained in the previously prepared suspension, on stainless steel foils. The film of Li₄Ti₅O₁₂ (approximately 1 micron) was deposited on the two faces of the substrate. These films were next heat treated at 600° C. for 1 h in order to weld the nanoparticles together, to improve the adhesion to the substrate and to complete the recrystallization of the Li₄Ti₅O₁₂.

b. Production of a Cathode Based on Li₁₊ₓMn_{2-y}O₄

Crystalline nanoparticles of Li₁₊ₓMn_{2-y}O₄ were prepared with x=y=0.05, as a cathode material, by grinding so as to obtain particle sizes of less than 100 nm. The nanoparticles of Li₁₊ₓMn_{2-y}O₄ were next dispersed in absolute ethanol at 25 g/l in order to obtain a suspension of nanoparticles of Li₁₊ₓMn_{2-y}O₄. This suspension was next diluted in acetone to a concentration of 5 g/l.

The positive electrodes were prepared by electrophoretic deposition of the nanoparticles of Li₁₊ₓMn_{2-y}O₄ with x=y=0.05 contained in the previously prepared suspension, on stainless steel foils. The thin film of Li₁₊ₓMn_{2-y}O₄ (approximately 1 micron) was deposited on the two faces of the substrate. These films were next heat treated at 600° C. for 1 h in order to weld the nanoparticles together, to improve the adhesion to the substrate and to complete the recrystallization of the Li₁₊ₓMn_{2-y}O₄.

c. Production, on the Anode and Cathode Layers Previously Produced, of a Porous Layer from a Suspension of Nanoparticles of Li₃PO₄

The suspension of nanoparticles of Li₃PO₄ was produced from the two solutions presented below.

45.76 g of CH₃COOLi, 2H₂O was dissolved in 448 ml of water, and then 224 ml of ethanol was added to the medium under energetic stirring in order to obtain a solution A.

16.24 g of H₃PO₄ (85 wt % in water) was diluted in 422.4 ml of water, and then 182.4 ml of ethanol was added to this solution in order to obtain a second solution, hereinafter referred to as solution B.

Solution B was next added, under energetic stirring, to solution A.

The solution obtained, perfectly clear after the disappearance of the bubbles formed during the mixing, was added to 4.8 liters of acetone under the action of a homogenizer of the Ultra-turrax™ type in order to homogenize the medium. A white precipitation in suspension in the liquid phase was immediately observed.

The reaction medium was homogenized for 5 minutes and was then maintained for 10 minutes under magnetic stirring. It was left to settle for 1 to 2 hours. The supernatant was separated and then the remaining suspension was centrifuged for 10 minutes at 6000 g. Next 1.2 liters of water was added in order to resuspend the precipitate (use of a sonotrode, magnetic stirring). Two additional washings of this type were next implemented with ethanol. Under energetic stirring, 15 ml of a solution of bis[2-(methacryloyloxy)ethyl]phosphate was added at 1 g/ml to the colloidal suspension in the ethanol thus obtained. The suspension thus became more stable. The suspension was next sonicated using a sonotrode. The suspension was next centrifuged for 10 minutes at 6000 g. The residue was next redispersed in 1.2 liters of ethanol and then centrifuged for 10 minutes at 6000 g. The residues obtained are redispersed in 900 ml of ethanol in order to obtain a 15 g/l suspension suitable for implementing an electrophoretic deposition.

Conglomerates of approximately 200 nm consisting of 10 nm primary particles of Li₃PO₄ were thus obtained in suspension in the ethanol.

Porous thin layers of Li₃PO₄ were next deposited by electrophoresis on the surface of the anode and cathode previously produced by applying an electrical field of 20 V/cm to the suspension of Li₃PO₄ nanoparticles previously obtained, for 90 seconds, to obtain a layer of approximately 2 μm. The layer was next dried in air at 120° C. and then a calcination treatment at 350° C. for 120 minutes was implemented on this previously dried layer in order to eliminate any trace of organic residues.

A plurality of anodes and respectively cathodes in thin layers were produced according to the method described above.

d. Production of a Battery Comprising a Plurality of Electrochemical Cells

A plurality of anodes and respectively cathodes, in thin layers, were produced according to example a) and respectively example b). These electrodes were covered with a layer of electrolyte using a suspension of Li₃PO₄ nanoparticles as indicated above.

After having deposited 2 μm of porous Li₃PO₄ on each of the electrodes (LiMn₂O₄ and Li₄Ti₅O₁₂) previously produced, the two subsystems were stacked so that the films of Li₃PO₄ are in contact. This stack comprising an alternating succession of cathode and anode in thin layers covered with a porous layer and the films of Li₃PO₄ of which were in contact, was next pressed hot under vacuum.

To do this, the stack was placed under a pressure of 5 MPa and then dried under vacuum for 30 minutes at 10⁻³ bar. The plates of the press were next heated to 550° C. at a speed of 0.4° C./second. At 550° C., the stack was next thermocompressed at a pressure of 45 MPa for 20 minutes, and then the system was cooled to ambient temperature.

Once the assembly was produced and then dried at 120° C. for 48 hours under vacuum (10 mbar), a multilayer rigid system consisting of a plurality of assembled cells was obtained.

A lithium ion battery comprising a plurality of electrochemical cells, each comprising electrodes according to the invention, was thus obtained.

e. Production of an Electrochemical Cell or of an Encapsulated Battery

An electrochemical cell and respectively a battery comprising a plurality of electrochemical cells was produced according to example e) and respectively example f). These devices were encapsulated by successive layers.

A first layer of parylene F (CAS 1785-64-4) approximately 2 μm thick was deposited by CVD on the electrochemical cell and respectively on the battery comprising a plurality of electrochemical cells.

A layer of alumina Al₂O₃ was next deposited by ALD on this first layer of parylene F. The electrochemical cell and respectively the battery comprising a plurality of electrochemical cells covered with a layer of parylene was introduced into the chamber of a Picosun™ P-300 ALD reactor. The chamber of the ALD reactor was previously put under vacuum at 5 hPa and at 120° C. and previously subjected for 30 minutes to a flow of trimethylaluminum (hereinafter TMA)—(CAS: 75-24-1), a chemical precursor of alumina under nitrogen containing less than 3 ppm of ultrapure water type 1 (σ≈0.05 μS/cm) as carrier gas at a rate of 150 sccm (standard cm³/min), in order to stabilize the atmosphere of the chamber of the reactor before any deposition. After stabilization of the chamber, a 30 nm layer of Al₂O₃ was deposited by ALD.

A layer of parylene F approximately 2 μm thick was next deposited by CVD on the second layer of alumina Al₂O₃.

A layer of alumina Al₂O₃ approximately 30 nm thick was next deposited by ALD, as indicated previously, on this third layer of parylene F.

On this fourth layer a layer of epoxy resin of approximately 10 μm was next deposited by dipping. This fifth layer was next hardened under ultraviolet (UV) so as to reduce the rate of degradation of the battery by atmospheric elements.

The stack thus encapsulated was next cut along cutting planes for obtaining an electrochemical cell, respectively a unitary battery, before the baring, on each of the cutting planes of the cathodic and respectively anodic current collectors of the electrochemical cell and respectively of the battery. The encapsulated stack was thus cut on two of the six faces of the stack so as to make the cathodic and respectively anodic current collectors visible.

This assembly was next impregnated, under anhydrous atmosphere, by dipping in an electrolytic solution comprising PYR14TFSI, and 0.7 M LiTFSI. PYR14TFSI is the usual abbreviation of 1-butyl-1-methylpyrrolidinium bis(trifluoromethanesulfonyl)imide. LiTFSI is the usual abbreviation of lithium bis-trifluoromethanesulfonimide (CAS no.: 90076-65-6). The ionic liquid enters the porosities instantaneously by capillarity. Each of the two ends of the system was maintained in immersion for 5 minutes in a drop of the electrolytic mixture, and then any residual surplus is eliminated by buffering.

f. Production of the Contact Units of an Encapsulated Electrochemical Cell or of an Encapsulated Battery

Contact units were next added at the place where the cathodic and respectively anodic current collectors are visible (not covered with insulating electrolyte). A suspension comprising a resin of the ConductiveX Electro-bond 62 type filled with graphite was diluted in toluene in order to reduce the viscosity of the suspension to a value of around 50 Kpcs. The ends of the electrochemical cell and respectively of the battery, encapsulated and cut, were dipped in this suspension comprising a resin of the ConductiveX Electro-bond 62 type filled with graphite. The first layer based on resin of the ConductiveX Electro-bond 62 type filled with graphite has a thickness of around 30 μm.

This first layer was then dried at 60° C. for 4 hours.

The ends of the electrochemical cell and respectively of the battery, encapsulated, cut and thus covered were dipped in an Applied Nanotech CU-IJ70 ink filled with copper nanoparticles having a dry extract of 50% by mass and a viscosity of between 10 and 20 cP. The thickness deposited was between 6 and 8 μm.

This second layer was then dried at 100° C. for 30 minutes and then sintered by exposing to a xenon lamp in single-pulse mode of 2 milliseconds at 2.6 kV with a distance of 2.5 cm between the lamp and the electrical contact unit.

The electrical contact unit was then immersed in a molten bath of the Sn—Zn alloy at 40% by mass, so as to form a third layer based on Sn—Zn.

The ends of the electrochemical cell and respectively of the battery, encapsulated, cut and thus covered with this third layer were then immersed for 35 minutes in a bath of tin sulfonate and boric acid at pH 4 maintained at 25° C. Pure tin was thus deposited at the ends of the electrochemical cell and respectively of the battery, encapsulated, cut and thus covered.

What is claimed is:

1. A Contact unit (40) for an electronic or electrochemical device such as a battery (1), intended to provide the electrical contact with an external conductive element, said electronic or electrochemical device comprising a contact surface (51) defining an electrical connection area (50), characterized in that the contact unit (40) comprises a first layer (41), disposed on at least the electrical connection area (50), this first layer (41) comprising a material filled with electrically conductive particles, preferably a polymer resin and/or a material obtained by a sol-gel process, filled with electrically conductive particles, and even more preferentially a polymer resin filled with graphite.

2. The Contact unit (40) according to claim 1, comprising a second layer (42, 42′) consisting of a metal foil or comprising metallic copper, disposed on a first layer of material filled with electrically conductive particles.

3. The Contact unit (40) according to claim 2, comprising a third layer (43) comprising pure tin and/or pure zinc and/or a tin-metal alloy, disposed on the second layer (42, 42′).

4. The Contact unit (40) according to claim 3, wherein the metal of the tin-metal alloy is selected from zinc, lead, palladium, gold, copper and a mixture thereof.

5. The Contact unit (40) according to claim 3, comprising a fourth layer (44) of pure tin or a fourth layer of an alloy comprising silver, palladium and copper, disposed on the third layer (43).

6. The electronic or electrochemical device including at least one contact unit (40) according to claim 1, the electronic or electrochemical device preferably being selected from a capacitor, a battery (1) and a lithium ion battery.

7. A method for manufacturing at least one contact unit (40) of an electronic or electrochemical device such as a battery (1), comprising:
a. providing an electronic or electrochemical device, said electronic or electrochemical device comprising a contact surface (51) defining an electrical connection area (50),
b. depositing on at least the electrical connection area (50), preferably on at least the contact surface (51), a first layer (41) of material filled with electrically conductive particles, preferably said first layer being formed by a polymer resin and/or a material obtained by a sol-gel process filled with electrically conductive particles.

8. The method for manufacturing at least one contact unit (40) according to claim 7, comprising, after step b), when said first layer is formed from polymer resin and/or a material obtained by a sol-gel process filled with electrically conductive particles, a drying step followed by a step of polymerizing said polymer resin and/or of said material obtained by a sol-gel process.

9. The method for manufacturing at least one contact unit (40), comprising, after step b) according to claim 7,
c. depositing, on the first layer (41), a metal foil, or an ink, preferably by dipping, including copper in the form of organocopper compounds or particles, preferably copper nanoparticles,
d. heat treating at least the second layer deposited in order to obtain a conductive layer (42, 42′).

10. The method according to claim 9, wherein the method comprises, after step d), on at least the electrical connection area (50) of the electronic or electrochemical device, coated with the first and the second layer, a step e) of depositing pure tin and/or zinc and/or a tin-metal alloy wherein the metal is selected from zinc, lead, palladium, gold, copper and a mixture thereof.

11. The method according to claim 10, wherein the method comprises, after the step e), on at least the electrical connection area (50) of the electronic or electrochemical device, coated with the first, with the second layer and with the third layer, a step f) of depositing a layer of pure tin by electrodeposition or of a layer of an alloy comprising silver, palladium and copper.

12. The Contact unit according to claim 2, characterized in that the metal foil is selected from aluminum foils, copper foils, titanium foils, molybdenum foils, stainless steel foils and foils comprising metallic copper.

13. The method for manufacturing at least one contact unit (40), comprising, after the polymerization step according to claim 8,
c. depositing, on the first layer (41), a metal foil, or an ink, preferably by dipping, including copper in the form of organocopper compounds or particles, preferably copper nanoparticles,
d. heat treating at least the second layer deposited in order to obtain a conductive layer (42, 42′).

14. The Contact unit according to claim 8, characterized in that the metal foil is selected from aluminum foils, copper foils, titanium foils, molybdenum foils, stainless steel foils and foils comprising metallic copper.
